(19) United States
(12) Patent Application Publication
(10) Pub. No.: US 2026/0356672 A1
(43) Pub. Date: Nov. 12, 2026

(54) METHOD FOR PRODUCING BORON SUBPHOSPHIDE B12P2 IN SHS

(71) Applicants: UNIVERSITE SORBONNE PARIS NORD, Villetaneuse (FR); CENTRE NATIONAL DE LA RECHERCHE SCIENTIFIQUE, Paris (FR); SORBONNE UNIVERSITE, Paris (FR)

(72) Inventors: Dominique VREL, PARMAIN (FR); Sarah DINE, Villetaneuse (FR); Yann LE GODEC, Paris (FR); Hicham MOUTAABBID, Sceaux (FR)

(21) Appl. No.: 19/136,054

(22) PCT Filed: Nov. 22, 2023
(86) PCT No.: PCT/EP2023/082737

§ 371 Date: Jun. 5, 2025

(30) Foreign Application Priority Data
Dec. 5, 2022 (EP) EP22211529

(51) Int. Cl. C01B 25/08

(52) U.S. Cl. CPC C01B 25/084

(57) ABSTRACT

A method for producing boron subphosphide B₁₂P₂ by self-propagating synthesis, the method comprising a step of mixing reactants, in the form of powders, followed by a step of initiating an exothermic reaction, the exothermic reaction being carried out in a closed chamber.

### FIELD OF THE INVENTION

The invention relates to the production of boron subphosphide B₁₂P₂, which has interesting mechanical, thermal, and electronic properties.

Boron subphosphide B₁₂P₂ has especially high hardness values, low density, high compressive strength and a very high melting temperature of around 2400 K.

### PRIOR ART

Boron subphosphide B₁₂P₂ is often seen as an impurity in methods that primarily intend to produce boron phosphide BP.

Nevertheless, various methods have been proposed in the prior art for the synthesis of boron subphosphide B₁₂P₂.

In a first type of synthesis, the boron subphosphide is deposited on a substrate, for example made of silicon or silicon carbide. Document US2004005768 (Hersee, 2005) describes epitaxial growth of boron subphosphide on a silicon carbide substrate by chemical vapor deposition.

According to a second type of synthesis, boron subphosphide B₁₂P₂ is obtained by thermal decomposition of boron phosphide BP, at a temperature of over 1500 K, in a reducing atmosphere. The document by Slack et al. (Melt growth and properties of B₆P crystals, Journal of the Physics and Chemistry of Solids 1983, vol. 44, no. 10, pages 1009-13, 10.1016/0022-3697(83)90151-8) describes the production of boron subphosphide, very similar in composition to B₁₂P₂, by heating boron phosphide BP to a temperature of 1250 °C for 11 hours, under a stream of hydrogen.

According to a third type of synthesis, boron subphosphide is obtained by direct synthesis from a boron powder and a phosphorus powder. The document by Yang et al. (Synthesis and cell refinement for icosahedral boron phosphide B₁₂P₂, 10.1017/s0885715600014949) describes such a method, the mixture of the two powders being inductively heated to 1400 °C for one hour, under an argon pressure of 50 bar (750 psi).

It has also been proposed to produce boron subphosphide B₁₂P₂ using a SHS (Self-propagating High-temperature Synthesis) method, sometimes referred to as combustion synthesis or self-propagating synthesis.

SHS methods have been proposed for the production of various ceramic materials (borides, silicides, oxides, nitrides, carbides, in particular titanium carbide) or intermetallic materials.

An SHS-type reaction involves the intimate mixing of reactants, usually in the form of powders, followed by high-pressure compaction. The reaction is then initiated by a sudden, local input of energy, in the open air. The reaction, which is highly exothermic, propagates until all the reactants have been consumed.

The principles of SHS methods are presented in the document by Tavadze et al. (Production of advanced materials by methods of self-propagating high-temperature synthesis, Springer, 2013). Sub-categories of SHS methods can be identified, see for example Morsi (The diversity of combustion synthesis processing: a review, J Mater Sci 2012, 10.1007/s10853.011-5926-5).

Mukhanov et al. (Self-propagating high-temperature synthesis of boron subphosphide B₁₂P₂, Journal of Superhard Materials 36, 2014, 10.3103/S1063457614010031) propose two syntheses of boron subphosphide B₁₂P₂ by an SHS method under argon atmosphere from a compacted element of reactants.

A first synthesis is carried out from a mixture of a B₁₂P₂O₂₃ glass and magnesium, under argon, according to the following reaction:

B₁₂P₂O₂₃+23 MG→B₁₂P₂+23 MgO

the reaction temperature being higher than 1300 K.

A second synthesis is a reduction of boron phosphate, according to the following reaction:

2 BPO₄+5 MGB₂+3 MG→B₁₂P₂+8 MgO.

US 2017203965 describes a method for producing boron phosphide BP comprising a step of mixing boron phosphate BPO₄ and magnesium metal, a step of compacting the mixture at a pressure of the order of 20,000 psi (137 MPa), and a step of ignition by applying an energy input, using a heated fuse wire, the compaction making it possible to reduce the formation of impurities such as subphosphide B₁₂P₂.

The synthesis methods of the prior art for the production of boron subphosphide B₁₂P₂ have a number of disadvantages. The methods for synthesizing boron subphosphide are slow, expensive, complicated, dangerous (use of toxic elements) and low-yielding, and the boron subphosphide B₁₂P₂ obtained is of low purity.

The use of long, high-temperature heat treatments is energy-intensive, polluting and dangerous, making such methods economically uncompetitive.

The methods for synthesizing boron subphosphide B₁₂P₂ are so time-consuming and difficult to implement that, despite its interesting mechanical, thermal and electronic properties, boron subphosphide B₁₂P₂ is still rarely used in industry.

### DISCLOSURE OF THE INVENTION

The invention aims to overcome the disadvantages of the methods of the prior art, by proposing the synthesis of boron subphosphide B₁₂P₂ in high volume, at low cost, with low energy consumption.

The invention offers a simple, safe, and fast solution for the production of boron subphosphide B₁₂P₂ with inexpensive reactants that are readily available in large quantities.

For these purposes, a method for producing boron subphosphide B₁₂P₂ by self-propagating synthesis is proposed according to a first aspect, the method comprising a step of mixing reactants, in the form of powders, followed by a step of initiating an exothermic reaction, the exothermic reaction being carried out in a closed chamber.

Advantageously, the method for producing boron subphosphide B₁₂P₂ by self-propagating high-temperature synthesis, advantageously at a temperature higher than 1800 K, comprises:
a step of homogeneous mixing of reactants, in the form of powders, comprising at least
an alkaline-earth metal such as magnesium or calcium, and
a compound comprising boron B and phosphorus P, such as boron phosphate BPO₄ or B₁₂P₂O₂₃
a step of filling a reactor with the homogeneous mixture of reactants, the reactor comprising at least one heating element and a layer of thermal insulator on an inner wall of the bottom of the reactor and a layer of thermal insulator on one or more inner side walls, the thermal insulator being chemically inert and intended to surround the homogeneous mixture of reactants during the reaction, and to separate it from the reactor walls,
   a step of covering the top of the homogeneous mixture of reactants with a layer of chemically inert thermal insulator,
   a step of hermetically sealing the reactor,
   a step of initiating an exothermic reaction in the homogeneous mixture of reactants, by triggering the heating element,
   a step of high-temperature exothermic reaction that self-propagates in the reactant mixture of the reactor to obtain the boron subphosphide B₁₂P₂.

The hermetic sealing of the reactor prevents the magnesium gas from escaping from the reactor at the time of the reaction, and enables thermal containment by avoiding contact with air, so that B₁₂P₂ of a high purity can be obtained, at least greater than 80%, and even advantageously greater than 90%.

During the exothermic reaction, temperatures of around 2000 K can be reached locally. The chamber in which the exothermic reaction takes place forms a closed reactor, preventing oxidation reactions.

In some embodiments, the reactants comprise phosphoric acid, boric acid and magnesium, the exothermic reaction being according to reaction equation (2)

12 H₃BO₃+2 H₃PO₄→B₁₂P₂O₂₃+21 H₂O, then

B₁₂P₂O₂₃+23 Mg→B₁₂P₂+23 MgO tm (2)

In other embodiments, the reactants comprise boron phosphate, magnesium and magnesium diboride, the exothermic reaction being according to reaction equation (1)

2 BpO₄+3 Mg+5 MgB₂→B₁₂P₂+8 MgO (1).

The chamber in which the exothermic reaction takes place forms a closed reactor, preventing the release of vapors, in particular magnesium vapors into the air, from the chamber. The boiling point of magnesium, at around 1363 K, is well below the temperatures of the exothermic reaction of around 2000 K.

Advantageously, magnesium is in excess in the reactant mixture, with respect to the stoichiometry of equation (1) or equation (2). In some embodiments, magnesium is in a 22% excess in the reactant mixture, with respect to the stoichiometry of equation (1).

Advantageously, magnesium diboride is in excess in the reactant mixture, with respect to the stoichiometry of equation (1).

The excess of magnesium in the reactant mixture ensures complete reduction of the reactants, and also helps control the final reaction temperature, by introducing additional heat capacity and high latent heat for melting and especially for boiling magnesium.

Advantageously, the step of homogeneous mixing of the reactants is carried out by means of a two-dimensional powder mixer or a three-dimensional dynamic powder mixer, such as a mixer capable of imparting rotational movements, translational movements and inversion movements to a mixing vessel, for example for a period of more than 1 hour, advantageously more than 10 hours. Such a mixer is, for example, of the type marketed under the Turbula® brand name.

In some embodiments, the initiation step comprises heating a resistive element. The resistive element is, for example, a tungsten filament. In particular embodiments, the tungsten filament has a diameter of around one hundred microns and a length of a few centimeters.

Advantageously, the method comprises a step of placing a thermally insulating material between the mixture of powdered reactants and the wall of the closed chamber. The thermally insulating material is advantageously chemically inert, for example sodium chloride powder, or another salt such as KCl or MgO, or mineral sand. Advantageously, the insulating material is in powder form.

Advantageously, the method includes a step of cooling the chamber forming the reactor, the chamber being kept closed until cooling is complete. Cooling, for example, is provided by circulating heat-transfer fluid.

The method comprises a step of extracting the product of the exothermic reaction, the product extracted from the reactor being subjected to grinding and washing, the washing advantageously comprising leaching.

In some embodiments, the powder resulting from grinding the product of the exothermic reaction is placed in a hydrochloric acid bath, and the solution obtained is then subjected to vacuum filtration, for example with nanometric filters selected especially in particular for their resistance to acids, such as Millipore-MF polyethersulfone filters.

In particular embodiments, washing comprises leaching with aqua regia.

Advantageously, the mixture of powdered reactants is not compacted prior to the initiation step. In other words, the mixture of powdered reactants is advantageously filled into the reactor without compaction.

No compaction means less powder handling, considerable time savings, and no need to purchase expensive equipment.

Advantageously, the filling rate in the reactor, corresponding to the ratio between the sample volume and the reactor volume, is greater than 25%.

In some embodiments, the method is such that:
the filling rate is greater than 25%, and
   the excess of magnesium is between 10% and 50%, advantageously between 20% and 25%, advantageously with an excess of magnesium diboride of up to 20%,
      making it possible to obtain temperatures in excess of 1500 °C throughout the reactant mixture during the self-propagating exothermic reaction step, in order to achieve a B₁₂P₂ purity in the mixture greater than 80%, advantageously greater than 95% B₁₂P₂.

Advantageously, the exothermic reaction is carried out without solvent.

Advantageously, the reactor has a volume allowing the production of boron subphosphide weights greater than 50 g, advantageously greater than 100 g, and even more advantageously greater than 500 g.

Advantageously, the filling step includes inserting an intermediate wall held in the internal space of the reactor, during the filling of the space between the inner side walls of the reactor and the intermediate wall with insulation, and then during the filling of the central volume of the reactor defined by the internal space of the reactor surrounded by the intermediate wall with reactant mixture up to a given height in the reactor.

According to a second aspect, the invention relates to a boron subphosphide B₁₂P₂ obtained according to the method presented hereinbefore, the boron subphosphide B₁₂P₂ obtained including:
B₁₂P₂ particles ranging in size from 50 to 500 nm, with rounded icosahedral shapes,
micron-sized B₁₂P₂ particles with a “faceted rod” morphology, for example between 1 and 10 microns in length.

Advantageously, a mixture comprising only:
boron subphosphide B₁₂P₂ as presented hereunder, and
boron phosphide BP,
   is proposed with a boron subphosphide B₁₂P₂ purity in the mixture greater than 90%, advantageously greater than 95%, advantageously greater than 98%.

According to a third aspect, the boron subphosphide obtained by a method as presented hereinbefore is proposed for use as a hard material in machining or cutting tools, wire-drawing dies, wear protection coatings, construction, mining or quarrying tools, drilling tools, armor-piercing ammunition and bulletproof vests.

According to a fourth aspect, the boron subphosphide obtained by a method as presented hereinbefore is proposed for use as a heat-conducting or thermoelectric material.

According to a fifth aspect, the boron subphosphide obtained by a method as presented hereinbefore it is proposed for use as a filler in a thermosetting resin.

According to another aspect, the boron subphosphide obtained by a method as presented hereinbefore is proposed for use as a neutron-absorbing material.

According to another aspect, the boron subphosphide obtained by a method as presented hereinbefore is proposed for use as a powder material for manufacturing a shielding ceramic by sintering.

### DESCRIPTION OF THE FIGURES

Further subjects and advantages of the invention will become apparent from the description of some embodiments, which is provided hereinafter with reference to the accompanying drawings, wherein:

FIG. 1 is an external view of three closed reactors with 50 g, 100 g, and 500 g capacities, respectively, for the synthesis of boron subphosphide B₁₂P₂;

FIG. 2 is a diffractogram of a boron subphosphide B₁₂P₂ powder obtained in a closed reactor with 100 g capacity as depicted in FIG. 1;

FIG. 3 shows two scanning electron microscope images of a powder of boron subphosphide B₁₂P₂ obtained in a closed reactor with 100 g capacity as depicted in FIG. 1;

FIG. 4 to 12 are views of the reactor filling steps, according to one embodiment.

### DETAILED DESCRIPTION OF THE INVENTION

The method advantageously uses a closed reactor, non-compacted reactants and leaching, to produce boron subphosphide B₁₂P₂ on a large scale and at low cost.

The leaching methods have been optimized to eliminate the reactants that are not converted to B₁₂P₂.

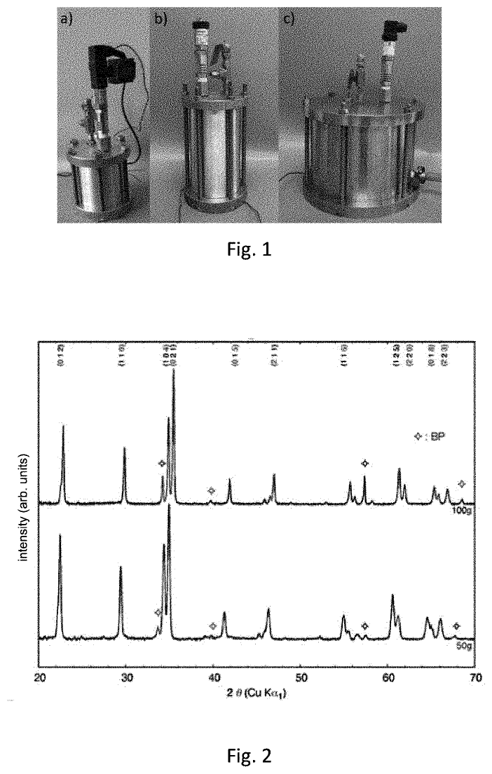

FIG. 1 depicts three closed reactors, which can contain sufficient amounts of reactants to synthesize 50 g, 100 g, and 500 g of powders, respectively.

The method for synthesizing boron subphosphide B₁₂P₂ is based on highly exothermic reactions between solid or gaseous reactants, in the absence of solvent. These redox reactions are as follows:

2 BpO₄+3 Mg+5 Mgb₂→B₁₂P₂+8 MgO

or

12 H3BO₃+2 H₃PO₄→B₁₂P₂O₂₃+21 H₂O, then

B₁₂P₂O₂₃+23 Mg→B₁₂P₂+23 MgO

In other embodiments, calcium is used instead of magnesium.

For the sake of simplicity, we have only presented herein the results for the boron subphosphide B₁₂P₂ synthesized using the reaction

2 BPO₄+3 Mg+5 MgB₂→B₁₂P₂+8 MgO.

The reactant mixture uses boron phosphate BPO₄ and magnesium diboride MgB₂ as boron and phosphorus sources, and magnesium Mg as the main reducing agent.

It should be noted that magnesium diboride MgB₂ also contributes to this role.

The reaction is extremely exothermic, with a final temperature that can exceed 2000 K, well above the boiling point of magnesium.

To ensure complete reduction of the reactants, magnesium is advantageously added in excess to the mixture.

This excess of magnesium makes it possible to control the final reaction temperature, by introducing additional heat capacity and high latent heat for melting and especially for boiling magnesium.

Furthermore, magnesium diboride MgB₂ is advantageously in excess in the mixture, so as to limit the amount of boron phosphide BP present as a by-product in the final powders of boron subphosphide B₁₂P₂.

These experimental conditions enabled the complete elimination of boron phosphate BPO4, and the final yield of the reaction was 80%.

This yield corresponds to the weight of boron subphosphide B₁₂P₂ obtained, with respect to what might have been expected based on the stoichiometry of the reaction.

Advantageously, an adiabatic temperature calculation is performed, using NIST (National Institute of Standards and Technology) databases of the various reaction products.

FIG. 2 shows X-ray diffractograms of the powder of boron subphosphide B₁₂P₂ obtained for 50 g and 100 g batches in the intermediate reactor with 100 g capacity depicted in FIG. 1. Rietveld refinement of the diffractograms was carried out using MAUD (Material Analysis Using Diffraction) software on these two powder batches.

Rietveld refinement is disclosed, for example, by Stephens (Uniting electron crystallography and powder diffraction, 2012, 10.1007/978-94-007-5580-2_2). Rietveld refinement is a method for the global simulation of X-ray diffraction patterns on polycrystalline samples, this method being implemented in various software packages such as FullProf, Jana2006, and MAUD. The MAUD software was developed by Luca Lutterotti (L. Lutterotti et al. MAUD: a friendly Java program for material analysis using diffraction. IUCr: Newsletter of the CPD, 21:14-15, 1999).

The powders consist of boron subphosphide B₁₂P₂ at 97.441% and boron phosphide BP as an impurity at 2.559%.

The rhombohedral structure is observed for the various diffractograms, with an R-3m space group. The mesh parameters of the boron subphosphide B₁₂P₂ are a=6.01025 Å and c=11.90010 Å in the hexagonal mesh.

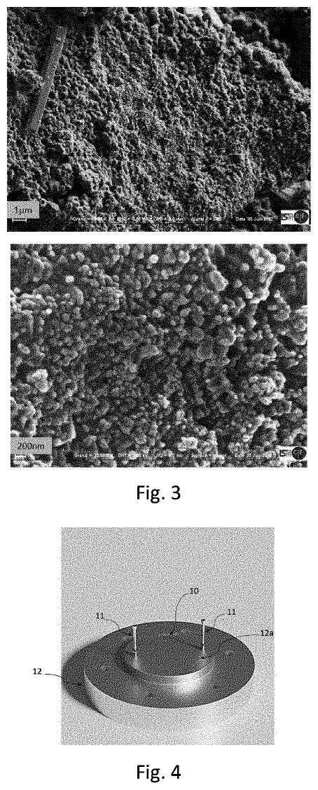

FIG. 3 shows the morphological analysis of the powders obtained, by scanning electron microscopy.

Two discrete particle populations are observed.

A very small number of particles are micron-sized, with a faceted rod-like morphology.

Otherwise, the vast majority of the particles of boron subphosphide B₁₂P₂ range in size from 50 to 500 nm, with slightly rounded icosahedral shapes.

The steps of a method will now be described in more detail.

The powders are first weighed, then homogenized in a mixer for 24 hours.

The mixer can be a rotary vessel mixer (cube, rotary drum, double cone), or a convective mixer comprising a stationary vessel and a movable member turning inside the vessel, a fluidized-bed mixer or a static mixer.

Advantageously, the mixer is of the complex-movement type, providing a rotational, translational, and inversion movement to a mixing container, the movements being pulsatory.

The mixer is, for example, of the type marketed under the Turbula® brand name by Willy Bachofen AG. A presentation of Turbula mixers is offered by Mayer-Laigle (Etude dynamique et effet du changement d'échelle pour plusieurs systèmes particulaires en mélangeur Turbula®, thesis 2012).

This mixer makes it possible to obtain a high-quality final mixture.

The powders are then placed in the reactor, surrounded in every direction by insulating walls, ensuring thermal and chemical insulation with the outer walls of the reactor.

The insulating wall is, for example, formed by a powdered material, such as sodium chloride or mineral sand.

The thickness of this thermally insulating wall must be selected to limit the cooling rate of the sample, which advantageously increases the purity of the product by reducing the amount of BP, and to allow a more gradual discharge of the heat and thus to avoid excessive heating of the reactor walls which could compromise their integrity.

For example, it is between 2 and 3 cm, for a characteristic transverse length of the homogeneous mixture of reactants of between 4 and 6 cm and a characteristic height of between 10 and 16 cm.

This cooling must be optimized to be slow enough to optimize the time the sample spends at high temperature, making it possible to maximize the amount of B₁₂P₂ to the detriment of BP, without compromising productivity. This time is, for example, from one to several hours.

This cooling is linked to all the characteristics of the thermal insulator. For example, for a powdered thermal insulator, allowing lower thermal conduction, the characteristics of the insulator include the particle size, the thickness of the insulator and the type of the insulator.

The magnesium was evaporated during the reaction, and is mixed with the insulating salts, and thus rapid opening would cause oxidation of the products and the magnesium, which would not allow the high reaction yields obtained by implementing the invention to be achieved.

FIG. 4 to 12 exemplify one embodiment of the filling of a Reactor.

In a first step, depicted in FIG. 4, a heating element 10 such as a resistive filament is placed at the bottom of the reactor. The resistive filament 10 is, for example, a tungsten filament. By way of illustration, the tungsten filament has a diameter of around one hundred microns and a length of a few centimeters. The two ends of the filament are each connected to a stud 11 mounted on the base 12 of the reactor, with an inner wall 12a in contact with the thermal insulator.

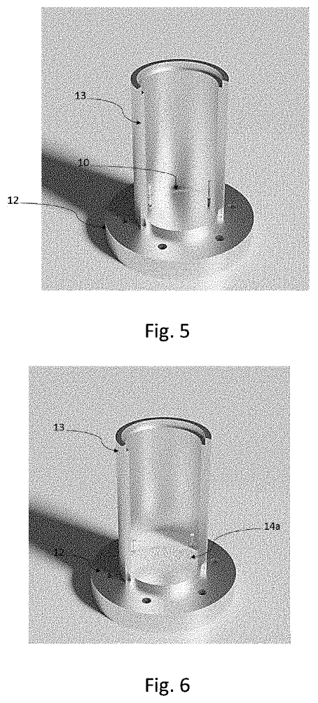

In a second step, depicted in FIG. 5, the inner wall 13 of the reactor is positioned on the base 12. In the depicted embodiment, the inner wall 13 is a cylindrical surface of revolution, the longitudinal axis of which is perpendicular to the base 12 of the reactor. In other embodiments, the inner wall is in the form of a profiled part with a square or polygonal cross-section. For ease of understanding, the wall 13 is depicted in partial cross-section in FIG. 5 to 11. The inner wall 13, for example, is fitted or inserted onto the base 12 of the reactor. When the inner wall 13 is in place, a volume inside the reactor is defined laterally by this inner wall 13 and by the base 12 of the reactor. This volume is open at the top, allowing the reactor to be filled. The resistive filament is placed inside this internal volume.

In a third step, depicted in FIG. 6, an insulating wall or base 14a is placed at the bottom of the internal volume of the reactor.

Advantageously, this insulating wall 14a or base is formed from a powder of a thermally insulating and chemically inert material, for example a salt powder such as sodium chloride or another salt, KCl or MgO, enabling thermal confinement during the reaction and avoiding, during the highly exothermic reaction, the migration of chemical elements from the walls of the reactor to the homogeneous mixture of reactants, making it possible to obtain high purity of the product obtained B₁₂P₂. The insulating wall 14a is thus easily positioned in the internal space of the reactor, below the resistive filament 10.

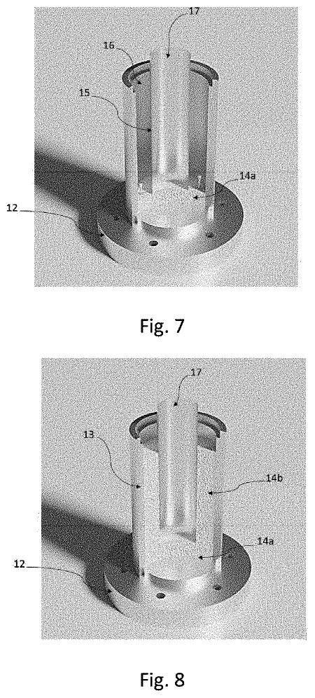

In a fourth step, depicted in FIG. 7, an intermediate wall or filling mold 15 is inserted and held in the internal space of the reactor, this inner wall separating a peripheral annular volume 16 from a central volume 17. In the depicted embodiment, the intermediate wall is in the form of a cylindrical part of revolution, for example a steel cylinder, such as a band. It must not damage the heating element 10 when it is inserted, and must have apertures or other openings to allow the filament to pass through, or be located resting on the filament located at the end of the height of the base 14a.

In a fifth step, depicted in FIG. 8, an insulating wall or side layer 14b is formed in the peripheral annular space 16, advantageously by filling this annular space with a powder of chemically inert insulating material. This powder is advantageously the same as the one used to form the insulating wall 14a at the bottom of the reactor R.

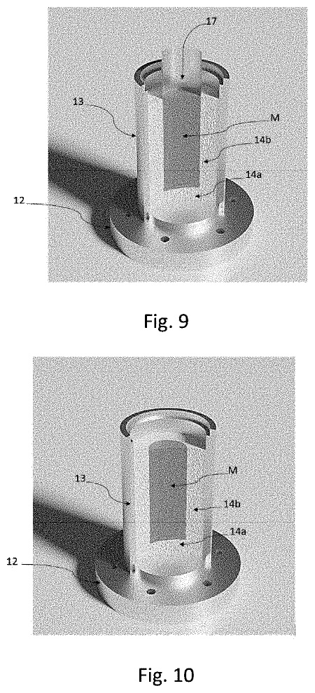

In a sixth step, depicted in FIG. 9, the mixture of reactive powder is placed in the central volume 17 of the reactor. This mixture of reactive powder is in contact with the resistive filament 10.

In a seventh step, depicted in FIG. 10, the intermediate wall or filling mold 15 is removed.

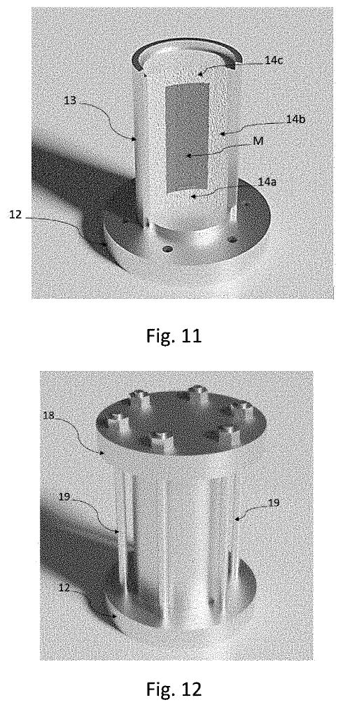

In an eighth step, depicted in FIG. 11, an upper insulating wall or layer is formed at the top of the reactor. Advantageously, this upper insulating wall or layer 14c is formed by an insulating and chemically inert powder, in particular the one used to form the insulating wall 14a at the bottom of the reactor (FIG. 6), or the one used to form the insulating wall or side layer 14b of the reactor (FIG. 8), for example a salt or sand powder. The insulating powder is placed in the reactor until it is completely filled.

In a ninth step, depicted in FIG. 12, the reactor is hermetically sealed, enabling the homogeneous mixture of reactants to be combined, thermally isolated from the atmosphere surrounding the reactor. Advantageously, the reactor comprises a lower flange forming the base 12 of the reactor and an upper flange forming the lid 18 of the reactor, with reinforcing rods 19 connecting the two flanges.

Once the reactor is hermetically sealed, the reaction is initiated, advantageously by a heating element such as a fusible heating filament, e.g. a tungsten filament, positioned within the reactive mixture. The tungsten filament has, for example, a diameter of around one hundred microns and a length of a few centimeters, and is heated by the Joule effect.

Once initiated, the reaction is complete within a few seconds.

The reactor is then kept closed until the sample has cooled down, after which it is extracted, ground and leached to dissolve the sodium chloride NaCl and the magnesium oxide MgO.

In one advantageous embodiment, the powders obtained are placed in a bath of 2M hydrochloric acid at 110 °C, under magnetic stirring for 1 h, in order to dissolve the magnesium oxide MgO and the sodium chloride NaCl.

The solution is then filtered under vacuum, for example using 220 nm Millipore-MF® polyethersulfone filters selected especially for their resistance to acids.

This operation is advantageously repeated twice in succession.

Advantageously, a final leach is carried out using aqua regia, with an HNO 3/HCl ratio of 1/3 to remove the last impurities.

The final product is then washed several times with distilled water to remove any residue from the surface of the powders.

Finally, the powders are dried in an oven.

Several parameters influence the yield of the reaction, and a parametric study was carried out, with the aim of obtaining the most complete reaction possible, by minimizing the oxide phase (BPO₄) and favoring the formation of boron subphosphide B₁₂P₂ over the formation of boron phosphide BP.

The excess of magnesium Mg advantageously enables better reduction of the oxide phase.

The excess of magnesium diboride MgB₂ advantageously reduces the amount of boron phosphide BP produced, while slightly improving the reducing power of the reaction mixture.

The overall volume of the reactor and the ratio between the volume of the sample and the weight of the reaction mixture determine the ratio between the volume of the sample and the volume of the reactor, i.e. the filling rate of the reactor with reaction mixture.

Advantageously:
the filling rate greater than 25%, and
   the excess of magnesium is between 10% and 50%, advantageously between 20% and 25%, allowing complete reduction of the oxide BPO₄.

In addition to this excess of magnesium, an excess of magnesium diboride of up to 20% can be added, matching the B:P stoichiometric ratio of 6:1 as closely as possible.

It has been found that a 22% excess of magnesium Mg, with no excess of magnesium diboride MgB₂, made it possible to achieve a yield approaching 80%.

The position of the sample in the reactor has a significant impact on the final purity of the product.

The purity of the boron subphosphide B₁₂P₂ in a reactor with 50 g capacity is thus 86%, and this purity rises to 98% in the intermediate reactor with 100 g capacity. In both cases, the main and only impurity in the boron subphosphide B₁₂P₂ is boron phosphide BP.

Advantageously, the reactor has an internal diameter of 10 cm and a height of 20 cm, with a total internal volume of 1,570 cm³.

Advantageously, the powder occupies a volume of between 180 cm³ and 350 cm³ in the reactor. These volumes correspond to cylinders with a diameter of 5 cm and a height of between 9 and 18 cm.

Advantageously, the reactant powder is not compressed to facilitate initiating the reaction.

Advantageously, the reactant powder has a low expansion capability, so that the different precursors remain in contact during the propagation of the reaction, enabling a more complete synthesis.

Advantageously, the entire reactor is filled, with the part not occupied by the reaction mixture containing an insulating material, for example sodium chloride or sand.

In this way, the residual heat is retained for longer, promoting self-purification phenomena and greatly favoring the synthesis of boron subphosphide B₁₂P₂ over the synthesis of boron phosphide BP.

At high temperatures, BP decomposes into B₁₂P₂, BP only being stable in air up to 1400 K (Mukhanov et al. Dalton trans., 2016, 45, 10122,DOI: 10.1039/c6dt00435k).

The method according to the invention has numerous advantages.

The method is safe, practical, fast and inexpensive, with simple implementation and easy scalability, for the production of boron subphosphide B₁₂P₂.

The method enables the synthesis of a material with high value-added, using low-cost reactants and an easy-to-implement device.

In addition, the method requires very little manpower, thus reducing costs.

By using SHS reactions in confined spaces (closed reactors), the method enables the synthesis of B₁₂P₂ powders in amounts of up to 100 g, using non-compacted reactants.

The yield is remarkably very high, around 80%.

The purity is also extremely high, around 97%.

The method is fast and requires very little energy. The invention thus enables the synthesis of boron subphosphide B₁₂P₂, in high volume, at low cost and with low energy consumption.

Until now, the use of this material with its exceptional mechanical properties has been underdeveloped, precisely because of the lack of large-scale synthesis possibilities with good economic potential.

The method enables production of this boron subphosphide B₁₂P₂ in high volume, the subphosphide being extremely hard, with remarkable chemical and thermal stability, the subphosphide being refractory, a wide-gap semiconductor and exhibiting thermoelectric power with a high figure of merit at high temperature.

The boron subphosphide obtained by the method according to the invention is advantageously used as a hard material, as an alternative to tungsten carbide.

The synthesis of tungsten carbide CW is very expensive, and is produced from elements at very high temperatures, between 1700 K and 2300 K.

In addition, tungsten carbide CW is sintered by adding a binder: cobalt. Chronic exposure to cobalt dust associated with tungsten carbide leads to occupational, cutaneous, respiratory and tumor diseases (see, for example, Robert (Analyse temporelle des expositions et des pathologies professionnelles françaises liées au cobalt et aux poussières de metaux durs, de la fin des années 1990 à 2020, pharmacy thesis, 2021).

Boron subphosphide B₁₂P₂ has far superior properties to tungsten carbide (harder, more resistant to chemical or thermal attack), and the method according to the invention is far less expensive than the one used to synthesize tungsten carbide CW.

Moreover, it is possible to sinter boron subphosphides without a binder, which suggests possibilities for sintering without a binder at low pressure by conventional methods.

The boron subphosphide B₁₂P₂ obtained (hardness ~35 GPa, comparable to commercial c-BN) is used in a wide range of applications currently reserved for tungsten carbide (or c-BN), such as machining and cutting tools (saws, drills, reamers, guide bushes, milling cutters, lathe tools, punches), wire-drawing or compacting dies, wear protection coatings (for turbine blades in aircraft engines, gas-fired power stations, metallurgical furnaces), heavy-duty tools (civil engineering, land levelling, drilling tool heads, mining and quarrying, tunnel boring machines), but also pen balls, armor-piercing ammunition, bulletproof vests.

The boron subphosphide obtained by the method according to the invention is advantageously used as a heat-conducting material, for example in integrated circuits.

As the power density of the microelectronic components continues to increase, the thermal load on these components increases exponentially.

With high heat densities, heat dissipation requires materials with remarkable thermophysical characteristics, such as hard materials like boron subphosphide B₁₂P₂.

The boron subphosphide obtained by the method according to the invention is advantageously used as a high-temperature thermoelectric material.

In the field of microelectronics, the boron subphosphide B₁₂P₂ can be p-type or n-type doped, enabling the production of diodes for use in harsh environments (chemical, thermal or mechanical), or for power electronics.

The boron subphosphide B₁₂P₂ may also find major applications as a high-temperature thermoelectric material.

The boron subphosphide obtained by the method according to the invention is advantageously used as a filler in a thermosetting resin.

The addition of a hard, light, thermally conductive material to thermosetting resins enhances their thermomechanical and chemical resistance.

These thermosetting materials are attracting growing interest for their remarkable properties: very good mechanical strength, as well as good resistance to chemicals (non-reactive materials) and heat.

The boron subphosphide obtained by the method according to the invention is advantageously used in the nuclear field, due to its high neutron absorption cross-section, as an alternative to boron or boron carbide.

Pure boron is difficult to produce in specific shapes (e.g. for control rods in nuclear power plants), which is why boron carbide is generally substituted for it in these applications, offering a high concentration of boron atoms in a solid, refractory form that is resistant to chemical attack.

Nevertheless, the production of boron carbide B₄C requires very high temperatures and is relatively complex.

The simplicity of low-cost synthesis of the boron subphosphide B₁₂P₂ may also make it possible to promote this material in nuclear applications, and thus to replace the boron carbide B₄C in certain special cases.

1. A method for producing boron subphosphide B₁₂P₂ by self-propagating high-temperature synthesis, at a temperature higher than 1500 °C, in a closed, thermally insulated reactor, the method comprising:
a step of homogeneous mixing of reactants, in the form of powders, comprising at least:
an alkaline-earth metal such as magnesium or calcium, and
a compound comprising boron and phosphorus, or a compound comprising boron and a compound comprising phosphorus, such as boron phosphate BPO₄ or B₁₂P₂O₂₃
a step of filling a reactor with the homogeneous mixture of reactants,
the reactor comprising at least:
a heating element,
a layer or base of thermal insulator on an inner wall of the bottom of the reactor and a side insulating layer on one or more inner side walls, the thermal insulator being chemically inert and intended to surround the homogeneous mixture of reactants during the reaction and to separate it from the walls of the closed reactor,
a step of covering the top of the homogeneous mixture of reactants, as well as the side insulating layer, with an upper layer of chemically inert thermal insulator, enabling the homogeneous mixture of reactants to be confined in the reactor, this mixture being completely surrounded by the base insulating layer, the side thermal insulating layer, and the upper thermal insulating layer,
a step of hermetically sealing the reactor with a lid,
a step of initiating, in the closed reactor, a high-temperature exothermic reaction in the homogeneous mixture of reactants, by triggering the heating element, in contact with the mixture,
a step of high-temperature exothermic reaction, at a temperature higher than 1500 °C, which self-propagates throughout the reactant mixture of the reactor to obtain the boron subphosphide B₁₂P₂,
the insulating material allowing the residual heat to be retained for longer in the homogeneous mixture of reactants, to promote self-purification phenomena and favor the synthesis of boron subphosphide B₁₂P₂ over the synthesis of boron phosphide, the mixture of reactants being said to be confined in the reactor,
the reactant powder thus has a low capacity for expansion, so that the various precursors remain in contact with one another as the reaction propagates,
the magnesium being in excess in the reactant mixture to enhance oxide reduction,
a step of extracting the product of the exothermic reaction, the product extracted from the reactor being subjected to washing that comprises leaching one or more times, followed by rinsing, in order to obtain the boron subphosphide B₁₂P₂.

2. The method according to claim 1, wherein the homogeneous mixing of the reactants is carried out by means of a two-dimensional powder mixer or a three-dimensional powder mixer, such as a mixer capable of imparting rotational movements, translational movements and inversion movements to a mixing vessel, for example for a period of more than 1 hour, advantageously more than 10 hours.

3. The method according to claim 1, wherein the filling and confinement of the mixture of powdered reactants in the reactor is carried out without compaction.

4. The method according to claim 1, wherein the filling rate in the reactor corresponding to the ratio between the volume of the reactant sample and the volume of the reactor is greater than 25%.

5. The method according to claim 1, wherein the reactants comprise phosphoric acid, boric acid and magnesium, the exothermic reaction being according to reaction equation (2)
12 H₃BO₃+2 H₃PO₄→B₁₂P₂O₂₃+21 H₂O, then
B₁₂P₂O₂₃+23 Mg→B₁₂P₂+23 MgO tm (2)

6. The method according to claim 1, wherein the reactants comprise boron phosphate, magnesium and magnesium diboride, the exothermic reaction being according to reaction equation (1)
2 BpO₄+3 Mg+5 MgB₂→B₁₂P₂+8 MgO (1).

7. The method according to claim 5, wherein magnesium is in excess in the reactant mixture, with respect to the stoichiometry of equation (1) or equation (2).

8. The method according to claim 6, wherein magnesium diboride is in excess in the reactant mixture, with respect to the stoichiometry of equation (1).

9. The method according to claim 6, wherein:
the filling rate greater than 25%, and
the excess of magnesium between 10% and 50%, advantageously between 20% and 25%, advantageously with an excess of magnesium diboride of up to 20%,
make it possible to obtain temperatures in excess of 1500 °C throughout the reactant mixture during the self-propagating exothermic reaction step,
in order to have a conversion rate of the reactants into B₁₂P₂, advantageously greater than 80%, and after leaching for only B₁₂P₂ and BP products, with a proportion of B₁₂P₂ advantageously greater than 95%.

10. The method according to claim 1, wherein the heating element is a resistive element, such as a tungsten filament.

11. The method according to claim 1, wherein the thermally insulating and chemically inert material is sodium chloride or another salt such as KCl, or MgO.

12. The method according to claim 1, wherein the method comprises a step of cooling the reactor, kept closed until the end of cooling, for example for a period of more than 1 hour and less than 10 hours, advantageously less than 5 hours, advantageously less than 2 hours.

13. The method according to claim 1, wherein the step of extracting the product of the exothermic reaction comprises a grinding step prior to leaching.

14. The method according to claim 1, wherein the washing of the extraction step comprises leaching one or more times, for example leaching one or more times with hydrochloric acid, followed by leaching with aqua regia.

15. The method according to claim 14, wherein the powder resulting from grinding the product of the exothermic reaction is placed in a hydrochloric acid bath, the solution obtained then being subjected to vacuum filtration, for example with nanometric filters selected especially for their resistance to acids, such as Millipore-MF® polyethersulfone filters.

16. The method according to claim 1, wherein the exothermic reaction is carried out without solvent.

17. The method according to claim 1, wherein the reactor has a volume making it possible to produce weights of B₁₂P₂ greater than 50 g, advantageously greater than 100 g, advantageously greater than 500 g.

18. The method according to claim 1, wherein the step of filling the reactor includes:
a step of filling the thermal insulator at the bottom of the reactor, to form a base of thermal insulator, for example up to the height of the heating element;
a step of inserting an intermediate wall or filling mold, held in the internal space of the reactor, for the duration of the filling operation;
by the thermal insulator, in the space between the inner side walls of the reactor and the intermediate wall, in order to create a layer of thermal insulator on the one or more side walls of the reactor,
by the reactant mixture, in the central volume of the reactor defined by the interior space of the reactor surrounded and delimited by the intermediate wall up to a given height in the reactor,
a step of removing the intermediate wall, and
a step of depositing a layer of chemically inert thermal insulator, to cover the top of the homogeneous mixture of reactants as well as the top of the side thermal insulating layer.

19. An end product obtained using the method defined by claim 1, wherein the end product has:
B₁₂P₂ particles ranging in size from 50 to 500 nm, with rounded icosahedral shapes,
micron-sized B₁₂P₂ particles with a “faceted rod” morphology.

20. The end product according to claim 19, comprising only:
boron subphosphide B₁₂P₂, and
boron phosphide,
with an amount of boron subphosphide B₁₂P₂ in the mixture greater than 90%, advantageously greater than 95%, advantageously greater than 98%, the remainder being boron phosphide.

21-25. (canceled)
